(19) United States
(12) Patent Application Publication
(10) Pub. No.: US 2017/0118957 A1
(43) Pub. Date: May 4, 2017

(54) Pet Toy with Multiple Molded Features

(71) Applicant: The KONG Company, LLC, Golden, CO (US)

(72) Inventor: Hoyt Samuel Nunn, Irvine, CA (US)

(21) Appl. No.: 14/926,277

(22) Filed: Oct. 29, 2015

(51) Int. Cl. A01K 15/02

(52) U.S. Cl. CPC A01K 15/025

(57) ABSTRACT

A pet toy has multiple molded features assembled in a nested configuration thereby forming separate layers. An embodiment includes an innermost molded layer or shell; an outermost molded layer or shell; and an intermediate layer or shell secured between the inner and outer shells. In another embodiment, the inner and outer shells are made from a flexible, elastomeric material, and the intermediate layer is made from a flexible layer such as a printed sheet material with graphics thereon that enhance the visual appearance of the pet toy. The inner and outer shells are sized such that the inner and outer shells make firm and uniform contact with one another to support and hold the intermediate layer without shifting. The thickness of each layer may be different. A squeaker may be incorporated by housing it within an interior chamber of the pet toy in a suspended position.

### FIELD OF THE INVENTION

The invention relates to pet toys, and more particularly, to a pet toy having multiple molded features that provide the pet toy with numerous responsive features when the toy is played with by an animal.

### BACKGROUND OF THE INVENTION

Due to the increased commercialization of pet products and particularly pet toys, there are now a wide range of commercially available pet toys with distinct functions. Pet toys can be made from many different types of materials along with a nearly limitless number of shapes and colors.

One general category of pet toys is those made of a flexible or elastomeric material, such as rubber. These toys, if made from quality materials, can withstand the biting action of an animal, and can keep an animal occupied for extended periods of time. It is known to place treats in these types of toys to increase the interaction of the animal with the toy. A sound emitting device, often referred to as a “squeaker”, is also known to be placed inside the toy to further stimulate the animal. Many rubber pet toys are made of a single layer of poor quality rubber material. An animal may therefore chew through and destroy the pet toy in a relatively short period of time.

Another general category of pet toys are those which may generally be referred to as “plush” toys. These types of toys are made from different types of cloth or fabric, and may also include material woven into strands, such as nylon rope. The plush toy is typically stuffed with a fibrous material, such as polyester stuffing, to provide the toy with an increased thickness or bulk that enables the animal to chew on the toy. Because the fibrous material is typically not strong enough to prevent the teeth of the animal from fully penetrating the outer cloth or fabric covering, plush toys are prone to being easily destroyed by the animal simply chewing through the outer covering. Plush toys may also include squeakers to further stimulate the animal.

Whether a pet toy is made from a flexible/elastomeric material or is a plush toy, the pet toys are typically made from one primary layer which defines the dominant characteristic of the pet toy in terms of its responsiveness to being chewed or otherwise played with. For example, a rubber toy with a single layer will typically deform in a uniform manner once it is chewed, and the pet toy will otherwise respond to activation by the animal in a uniform or consistent manner. If a squeaker is incorporated within the pet toy, the activation of the squeaker can also be generally defined as being uniformly responsive to activation by the animal chewing on the toy to generate sound. For plush toys, the reaction or response can also be generally characterized as being uniform or consistent, considering the toys are typically made from a single layer of material and are stuffed with a single type of material.

Considering the common forms of construction for many types of pet toys, there is a need to provide a pet toy with multiple responsive features which may help to entertain an animal longer. There is also a need to provide a pet toy that is robust enough to withstand the prolonged biting action of an animal, but is relatively simple in construction and therefore can be produced at a reasonable cost. There is also a need to provide a pet toy that has multiple responsive features that do not fall within the same general category of pet toys, which may further enhance the entertainment value of the toy for an animal.

The invention described below provides solutions to many limitations in the prior art, yet incorporates a construction that is robust enough to withstand the prolonged biting action of an animal. The invention also provides a pet toy that is relatively simple in structure, but provides multiple distinct features which may enhance an animal's interaction with the pet toy.

### SUMMARY OF THE INVENTION

The invention includes a pet or animal toy having multiple molded features. These molded features are placed in a stacked or nested configuration in which each molded feature can be considered a separate layer or substrate. Each molded feature can be made from a desired material which can impart or generate a desired response to the biting or play action with the pet toy.

According to one preferred embodiment of the invention, the pet toy may include an innermost molded part, layer, or shell; an outermost molded part, layer, or shell; and an intermediate molded part, layer, or shell that is secured between the inner and outer shells.

According to another preferred embodiment, the inner and outer shells are made from a flexible, elastomeric material, and the intermediate layer is made from a flexible layer such as a printed sheet material with graphics thereon which enhance the visual appearance of the pet toy.

The inner and outer shells may be sized such that when the pet toy is assembled, the inner and outer shells remain in contact with one another; that is, the outer surface of the inner shell is sized to make firm and uniform contact with the interior surface of the outer shell. The intermediate layer or shell is “sandwiched” between the inner and outer shells, and is maintained in a substantially supported position so that it does not shift or move between the inner and outer shells.

According to another embodiment, the pet toy may further include a noisemaking device, commonly referred to as a “squeaker”. According to this embodiment, the squeaker has a stem or flange that is held by half sections of the pet toy that are joined when the pet toy is assembled. The squeaker is therefore maintained in a generally suspended or supported position in which the biting action of an animal does not result in direct contact of the animal's mouth with the body of the squeaker which is housed within the inner shell. From this supported or suspended position, the squeaker is able to pass air so that a consistent noise can be generated from the squeaker whenever the pet toy is squeezed or otherwise deformed. Further, this suspended or supported position of the squeaker protects it from the outside forces generated by an animal or pet owner.

Because the pet toy has multiple layers or multiple molded features, the overall strength of the pet toy may be enhanced because the thickness of the toy is greater as compared to single layer pet toys. Additionally, because there is more than one shell or layer, this provides the pet toy designer with multiple options for creating specific characteristics as to how the pet toy deflects or deforms in response to exterior pressure. For example, it may be desired to provide a very durable, tough pet toy in which the inner and outer shells are made from high-quality rubber which is quite resilient to the biting action of an animal. In yet another example, it may be desired to provide a softer exterior surface with a more robust or strong interior shell so that there is a discernible differential in how the pet toy feels to the animal. In yet another example, it may be desired to provide a clear or semi-clear outer shell so that the graphic features of the intermediate layer may be easily viewed without obstruction. The outer shell may also prevent damage to the intermediate layer by the biting action of the animal. Yet further, it may be desired to make the inner and outer shells of different colors so that the color differential between the shells enhances the graphics of the intermediate layer, or may otherwise provide a distinct visual appearance.

According to one preferred embodiment, the inner and outer shells may be made from thermoplastic rubber (TPR). Under one general description or definition of TPR, it may be considered a thermoplastic rubber that has melting and/or molding properties of plastic while still maintaining some advantageous flexible and elastomeric properties of rubber. One distinguishing characteristic of TPR as compared to a thermoplastic elastomer or (TPE) is that a TPR may have a “shiny” or reflective side. In this regard, having one surface that is reflective may enhance the visual characteristics of the toy.

Different materials may be used to form the inner and outer shells. Preferably, the outer shell is formed of a material that is durable and of a quality to prevent teeth of an animal from penetrating the outer shell and damaging the inner shell and the intermediate layer. The outer shell may also be denser or thicker than the inner shell to provide added strength to the pet toy or to limit damage to the pet toy by the teeth of the animal.

According to another aspect of the invention, the intermediate layer may be made from a sheet material or more than one layer of sheet material with graphics that enhance the visual presentation of the pet toy. Considering the intermediate layer is securely retained between the inner and outer shells, the intermediate layer will therefore remain substantially intact despite the use of the pet toy in which the inner and outer shells may become repeatedly deformed or compressed in response to the play action of the animal.

The specific shape of the pet toy may take many forms. Considering that the inner and outer shells may be made in a molding process, current molding technology therefore permits the molding of complex shapes so that the pet toy may take many different forms. Commensurate with specific embodiments disclosed herein, examples of shapes for the pet toy may include a round shape, a star shaped, a bone shape, a stick or twig shape, and others. Each of these shapes may incorporate the multi-layered configuration in which an intermediate layer is disposed between an inner shell and outer shell.

Although preferred embodiments disclosed herein adopt a multilayered configuration with the inner and outer shells, along with the intermediate layer, it is also specifically contemplated that the pet toy may incorporate additional layers or shells, which may further provide some additional strength and/or resilience for the toy.

According to one general method of manufacture, the pet toy may include inner and outer shells that are originally molded in half or bisected sections, and assembly of the half/bisected sections is achieved along matching and opposing side edges of the half sections. In order to increase the ease of joining the half sections, as well as to increase the strength and durability of the connection between the half sections, a “tongue and groove” configuration may be adopted in which one joining edge includes a groove or recess, and the matching edge of the other half section includes a tongue or flange received in the groove/recess.

Considering the above features and characteristics of the invention, in one aspect of the invention, it may be considered a pet toy comprising: an outer shell made of a first material; an inner shell made of a second material; an intermediate graphics layer positioned between and supported by the inner and outer shells; and a noise making device having a first end supported by the inner and outer shells, and a second end extending within an interior chamber of the pet toy defined as space within interior surfaces of the inner shell, and wherein the second end is suspended and spaced from the interior surfaces. In one embodiment, the first material comprises a first TPR material and the second material comprises a second TPR material. Optionally, the first material may be the same as the second material.

Other features of the first aspect invention may include: (i) the outer and inner shells are molded in respective half sections and are joined to one another to assemble the pet toy; (ii) the half sections are each substantially symmetrical about an axis; (iii) the half sections of the inner and outer shells are sectioned along a substantially common joining line defined by contact between opposing joining surfaces of the half sections; (iv) one half section of an outer shell includes a peripheral flange and a groove or protrusion formed with the peripheral flange; and (v) the other half section of the outer shell includes a corresponding groove or protrusion for mating with the groove or protrusion of the one half section.

In another second aspect of the invention, it may be considered a pet toy comprising: (i) an outer shell made of a first thermoplastic material; (ii) an inner shell made of a second thermoplastic material; (iii) an intermediate graphics layer positioned between and supported by the inner and outer shells; (iv) a noise making device having a first end supported by the inner and outer shells, and a second end extending within an interior chamber of the pet toy defined as space within interior surfaces of the inner shell, the second end being suspended and spaced from the interior surfaces; (v) the outer and inner shells being molded in respective half sections and joined to one another to assemble the pet toy; and (vi) the half sections are sectioned along a substantially common joining line defined by contact between opposing joining surfaces of the half sections.

Others features of the invention in connection with the foregoing second aspect may include: (i) the outer shell is translucent or substantially transparent so that the intermediate graphics layer can be viewed; (ii) one half section of an outer shell includes a peripheral flange and a groove or protrusion formed with the peripheral flange, and the other half section of the outer shell includes a corresponding groove or protrusion for mating with the groove or protrusion of the one half section; (iii) one shell of the outer or inner shells is made of a first elastomeric material having a first deformation strength, and (iv) the other shell of the inner and outer shells is made of a second elastomeric material having a second deformation strength.

According to yet another aspect of the invention, it may include a method of stimulating an animal for play with a pet toy, the method comprising: (i) providing a pet toy including: an outer shell made of a first TPR material; an inner shell made of a second TPR material; an intermediate graphics layer positioned between and supported by said inner and outer shells; and a noise making device having a first end supported by said inner and outer shells, and a second end extending within an interior chamber of said pet toy defined as space within interior surfaces of said inner shell, and wherein said second end is suspended and spaced from said interior surfaces; (ii) giving the pet toy to an animal for play; and (iii) wherein the animal plays with the toy including biting the pet toy in which the inner and outer shells provide a differential resilient and elastomeric response to the biting action of the animal.

Other features and advantages of the invention will become apparent from a review of the following detailed description, taken in conjunction with the corresponding drawings. In certain instances, details that are not necessary for an understanding of the disclosure or that render other details difficult to perceive may have been omitted from the drawings. It should be understood, of course, that the invention is not necessarily limited to the particular embodiments illustrated herein. Additionally, it should be understood that the drawings are not necessarily to scale.

### BRIEF DESCRIPTION OF THE DRAWINGS

FIG. 1 is an exploded side view of the pet toy of the invention in a first embodiment;

FIG. 2 is a side view of the pet toy of FIG. 1 as assembled;

FIG. 3 is a cross-section illustrating interior details of the pet toy of FIG. 1;

FIG. 4 is an exploded side view of the pet toy of the invention in a second embodiment;

FIG. 5 is a side view of the pet toy of FIG. 4 as assembled;

FIG. 6 is a plan view of the pet toy FIG. 4;

FIG. 7 is a cross-section illustrating interior details of the pet toy of FIG. 4;

FIG. 8 is an exploded perspective view of the pet toy of the invention in a third embodiment;

FIG. 9 is a side view of the pet toy of FIG. 8 as assembled;

FIG. 10 is a plan view of the pet toy FIG. 8;

FIG. 11 is a first end view of the pet toy of FIG. 8 taken along line 11-11 of FIG. 10;

FIG. 12 is a second end view of the pet toy of FIG. 8 taken along line 12-12 of FIG. 10;

FIG. 13 is a cross-section view taken along line 13-13 of FIG. 10 illustrating interior details of the pet toy of FIG. 8, and line 13-13 also defining an exemplary axis about which half sections of the shells or layers are substantially symmetrical;

FIG. 14 is an exploded perspective view of the pet toy of the invention in a fourth embodiment;

FIG. 15 is a perspective view of the pet toy of FIG. 14 as assembled;

FIG. 16 is a plan view of the pet toy of FIG. 14 as assembled;

FIG. 17 is a cross-section illustrating interior details of the pet toy of FIG. 14;

FIG. 18 is an exploded side view of the pet toy of the invention in a fifth embodiment;

FIG. 19 is a side view of the pet toy of FIG. 18 as assembled;

FIG. 20 is a plan view of the pet toy FIG. 18;

FIG. 21 is a cross-section illustrating interior details of the pet toy of FIG. 18; and

FIG. 22 is a cross-section taken along line 22-22 of FIG. 20.

### DETAILED DESCRIPTION

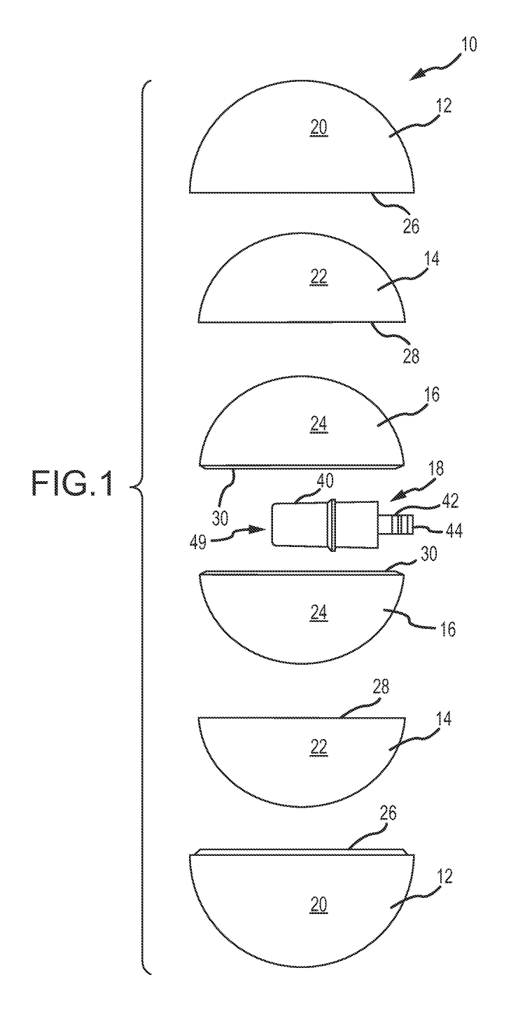

The pet toy of the invention 10 is illustrated in a first preferred embodiment at FIGS. 1-3. The particular construction of the pet toy 10 in this first embodiment shows a three layered structure with corresponding groups of half sections that are assembled to complete the toy. Specifically, FIG. 1 shows the pet toy 10 as having an outer layer or shell 12, and inner layer or shell 16, and an intermediate layer or shell 14 which is disposed between the inner and outer shells. These layers or shells are provided in half sections which are joined to one another along facing edges or joining surfaces 26, 28, and 30, as best shown in FIG. 1. A noisemaking device such as a squeaker 18 is arranged within an interior space or chamber of the pet toy as defined by the open space within the interior of the inner shell 16. Each of the shells/layers have complementary shapes such that when the pet toy is assembled, the shells/layers remain in a nested configuration in which substantially all of the facing surface areas of the respective shells/layers contact one another. The shells and layers may have similar or different cross-sectional thicknesses. For example, the outer shell 12 may be thicker than the inner shell 16. However, the outer shell may also be thinner than the inner shell 16. In one embodiment, the outer shell 12 and the inner shell 16 are of approximately the same thickness.

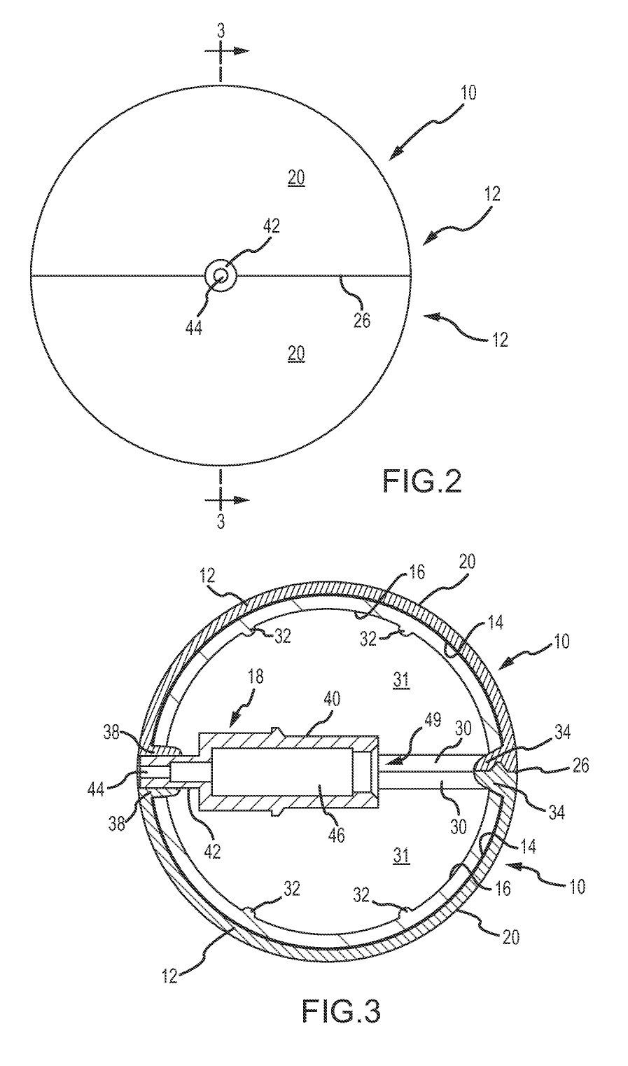

Referring to FIGS. 2 and 3, the squeaker 18 is disposed within the interior chamber of the pet toy as defined as the space within the interior surface 31 of the inner shell 16. Optionally, interior supporting ribs or protrusions 32 may be incorporated on the interior surface 31 of the inner shell in order to provide additional strength to the pet toy. Protrusions 32 may optionally be incorporated on interior surfaces of the outer shell 12 and the intermediate shell 14. The protrusions may provide a predetermined amount of separation between one or more of the shells.

The inner and outer shells may be joined to one another along their corresponding joining surfaces by a desired mating or connection arrangement. The example illustrated in FIG. 3 resembles a “tongue in groove” configuration 34 in which one half section of the outer shell 12 incorporates a tongue or extension, and the other half section incorporates a groove or recess to receive the tongue/extension. This tongue and groove configuration may extend around the entire periphery of the joining surfaces 26, or may be incorporated only upon selected sections of portions of the joining surfaces 26. Similarly, the joining surfaces 30 of the inner shell 16 may also incorporate a desired mating or connection arrangement. The half sections may be joined by heat welding, by an acceptable food grade adhesive, or combinations thereof.

As also shown in FIG. 3, an opening 38 may be formed in the area adjacent the joining surfaces 26 to receive a neck 42 of the squeaker 18. An orifice or opening 44 extends through the neck and communicates with an interior open-space 46 of a body 40 of the squeaker 18. Within the open-space 46, a noise producing element, such as a flexible reed (not shown), may be mounted so that air traveling through the body of the squeaker results in vibration of the reed to generate sound. Accordingly, the interior chamber of the pet toy communicates with an opening 49 the body 40 of the squeaker. The inner surfaces defining the opening 38 provide an upper surface area so that the neck 42 of the squeaker 18 may support the squeaker in a suspended position as shown. Thus, the body 40 of the squeaker maintains a spaced relationship with the interior surface 31 of the inner shell. In this suspended position, the squeaker is therefore able to more reliably generate sound as compared to if the squeaker was mounted in contact with the interior surface 31 of the inner shell 16 in which operation of the squeaker might become inhibited if compression of the toy resulted in blocking flow of air through the squeaker. Placing the squeaker in the illustrated suspended position also helps to protect the squeaker within the interior of the pet toy from outside contact or force.

Optionally, the squeaker 18 may be suspended within the interior surface 31 of the inner shell 16 at an angle such that the distal end of the squeaker with the opening 49 is not parallel to the interior surface 31. Arranging the squeaker 18 in this manner helps prevent the squeaker opening 49 from being obstructed by the shell interior surface 31, for example, when the pet toy 10 is deformed or collapsed during play by an animal. Alternatively, the squeaker 18 may be formed with a distal end formed at an angle to the squeaker body 40. In another embodiment, the neck 42 is formed with an angle such that the distal end of the squeaker body 40 is not parallel to the interior surface 31.

As an animal chews or bites on the pet toy 10, the volume of air within the hollow interior formed by interior surface 31 will change, therefore forcing air through opening 49 into the squeaker 18 and out of the other opening 44 of the squeaker 18. The air passing through the squeaker 18 generates noise. As the body of the pet toy 10 returns to its normally un-deformed shape, air will travel in an opposite direction from the opening 44, through the squeaker 18, and back through opening 49 into the hollow interior of the pet toy 10.

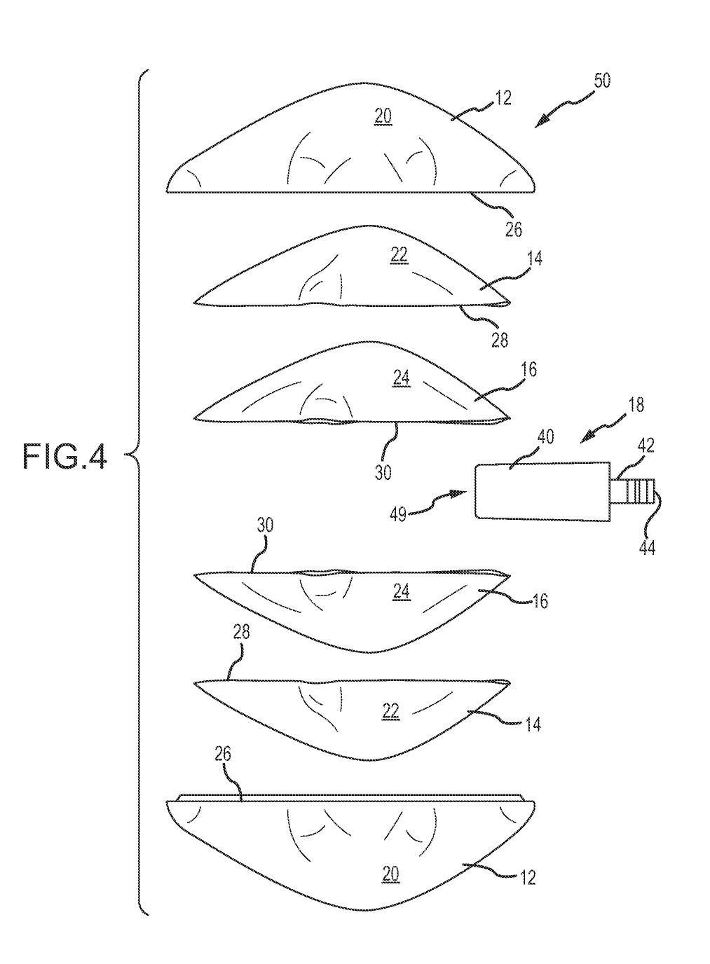

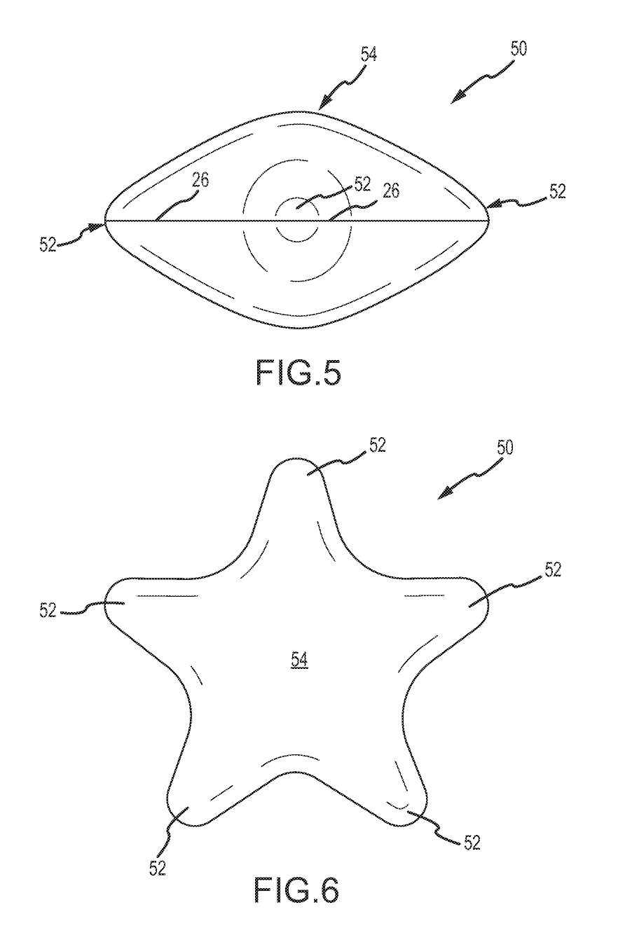

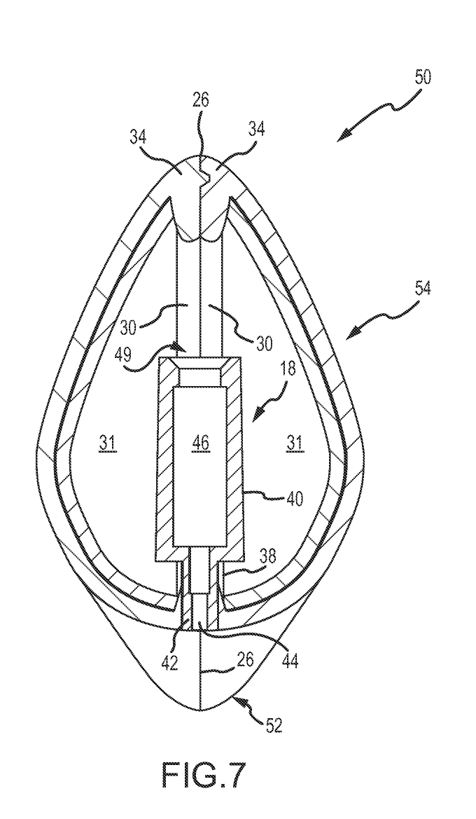

Referring to FIGS. 4-7, another preferred embodiment is illustrated in which a toy 50 has a star shape with five projections 52. Use of the same reference numbers in this embodiment correspond to the same or similar structural features from the first embodiment. This preferred embodiment also adopts a three layered configuration with the outer shell 12, the inner shell 16, and the intermediate layer 14. This star shaped embodiment has a central body 54 defining the cavity which receives the squeaker 18. FIG. 7 shows that the squeaker can be disposed in the suspended position which helps to protect the squeaker.

Also similar to the first embodiment, in this second embodiment, as shown in FIG. 7, the connection between the two half-sections of the outer shell is illustrated as a “tongue in groove” configuration 34 in which one half section of the outer shell incorporates a tongue or extension, and the other half section incorporates a groove or recess to receive the tongue/extension.

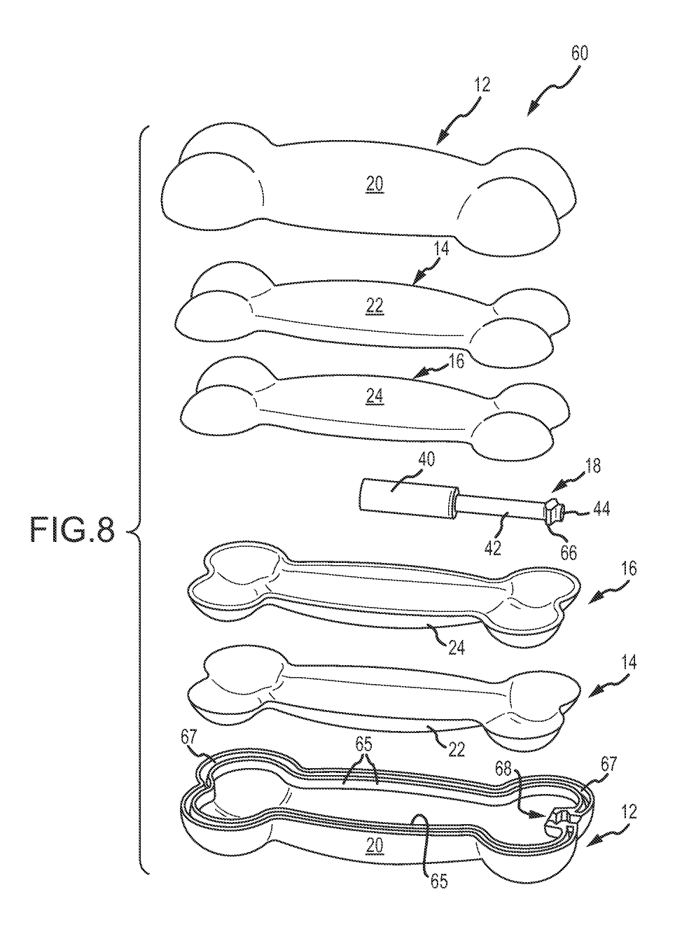

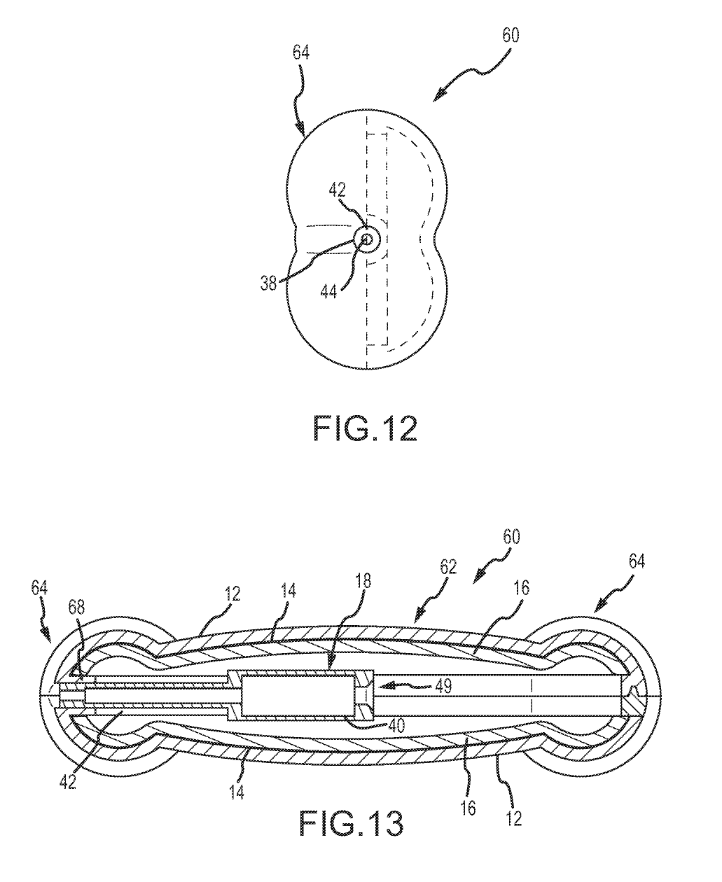

Referring to FIGS. 8-13, another preferred embodiment is illustrated in which a toy 60 has a bone shape. The bone shape of this third embodiment can be defined as including a body 62 and an enlarged bone ends or joints 64 disposed at each end of the body. The same reference numbers in this embodiment correspond to the same or similar structural features from the first embodiment. This preferred embodiment also adopts the three layered configuration with the outer shell 12, the inner shell 16, and the intermediate layer 14. The body 62 defines the cavity which receives the squeaker 18. As shown in FIG. 13, again the squeaker can be disposed in the suspended position which helps to protect the squeaker. One additional feature shown in this embodiment is the use of a protruding peripheral flange 65 on one of the halves of the outer shell 12. More specifically, the lower outer shell 12 is shown with this flange 65 that extends inwardly along the periphery of the shell 12. The flange 65 includes a uniform recess 67 which receives a corresponding tongue or protrusion (not shown) of the upper outer shell 12.

FIGS. 8 and 13 also show the squeaker 18 has a different shape in that the body 40 and the neck 42 are both of relatively smaller diameter and are both elongated. This change in shape of the squeaker 18 is responsive to the narrower central cavity as defined by the shape of the body 62. Referring to FIG. 8, the squeaker 18 is also modified to include a protruding wedge 66. The wedge 66 is received in a frame portion 68 formed on one end of the peripheral flange 65. The frame portion 68 is shaped to surround the wedge 66 and to therefore provide additional structural support to maintain the squeaker in the suspended position. The wedge 66 and corresponding frame portion 68 may be incorporated in the pet toys of all embodiments of the present invention.

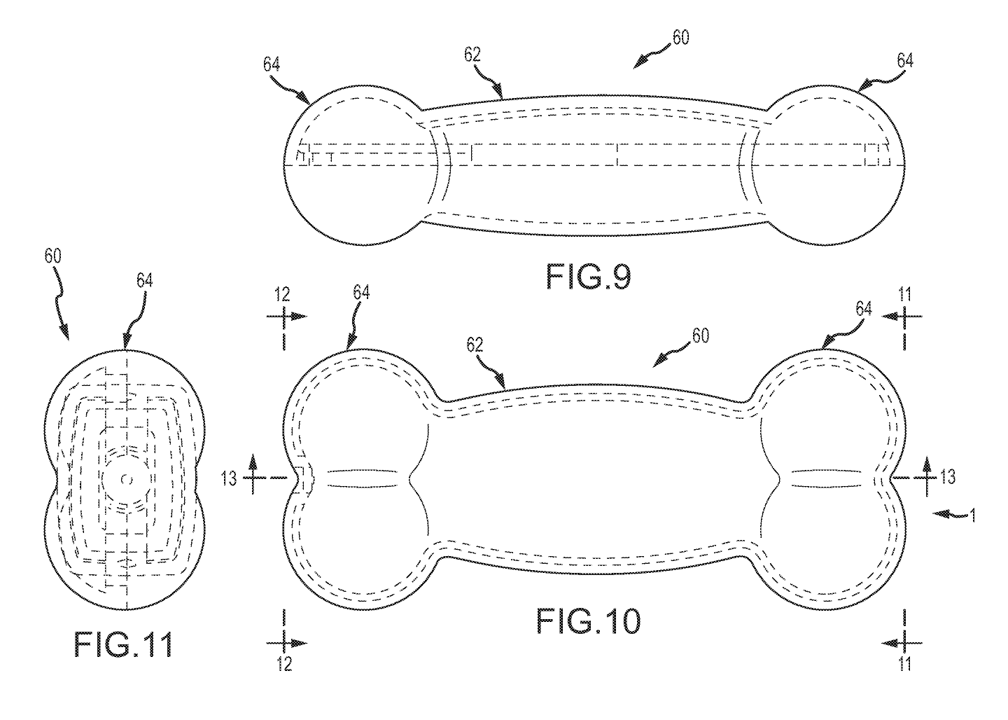

FIGS. 9-12 also show the arrangement of some of the interior elements of the pet toy, these interior elements being shown in dotted lines. As shown, the layers of materials form a concentric cross sectional pattern at various locations in which the complementary shapes of the layers resemble a multi-layered structure of flexible material that may be adhesively connected or thermally bonded between layers. However the structure of the present invention involves separate molded pieces that do not require adhesive or any other bonding material, except for closure of the respective outer shell halves in which some adhesive may be used. Further, because most types of bonding agents are not acceptable for use with pet toys due to their caustic nature, the invention avoids or minimizes the added expense of those special adhesives or other bonding agents that are classified as safe for animal consumption/exposure.

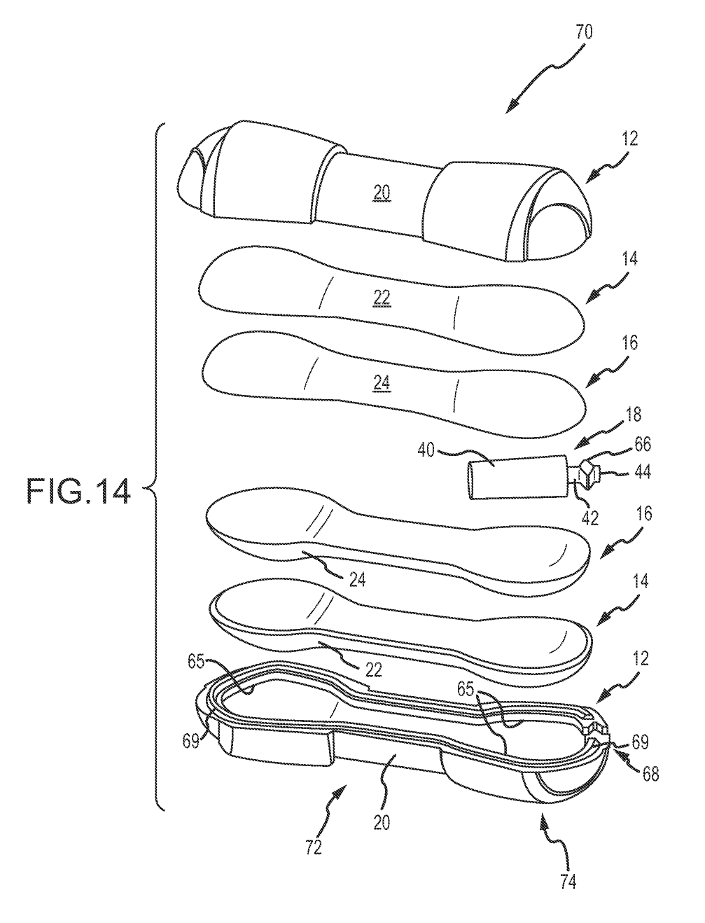

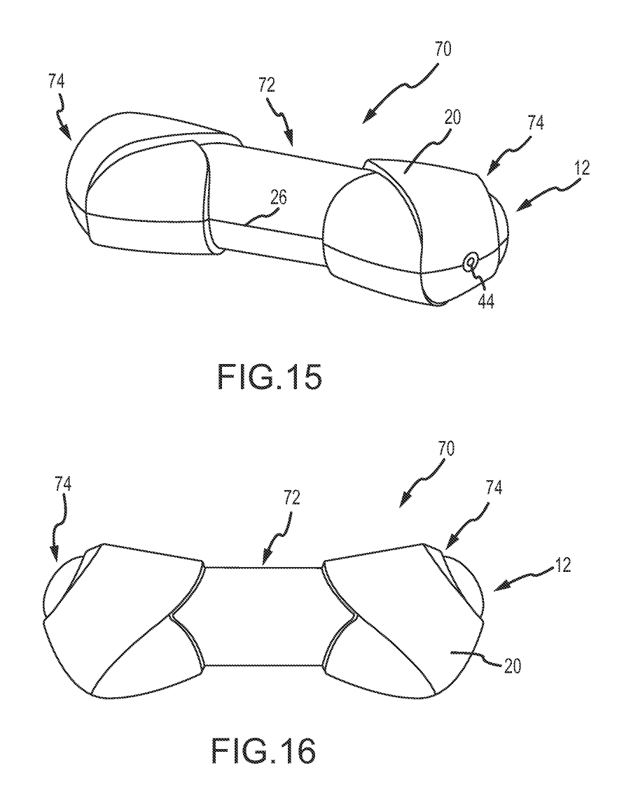

Referring to FIGS. 14-17, yet another preferred embodiment is illustrated in the shape of a rawhide “bone” 70. The shape of this fourth embodiment can be described as including a body 72 and tied or knotted ends 74 that are disposed at each end of the body 72. Referring to the other figures, this embodiment also incorporates the same general construction in which the shells or layers of material are concentrically arranged, and a squeaker 18 is disposed within the interior center chamber of the toy in the suspended orientation. This embodiment also incorporates the use of a protruding peripheral flange 65 on one of the outer shells, but instead of a uniform recess 67, the lower outer shell 12 is shown with a uniform tongue or protrusion 69 that is placed within a corresponding groove (not shown) in the upper outer shell 12.

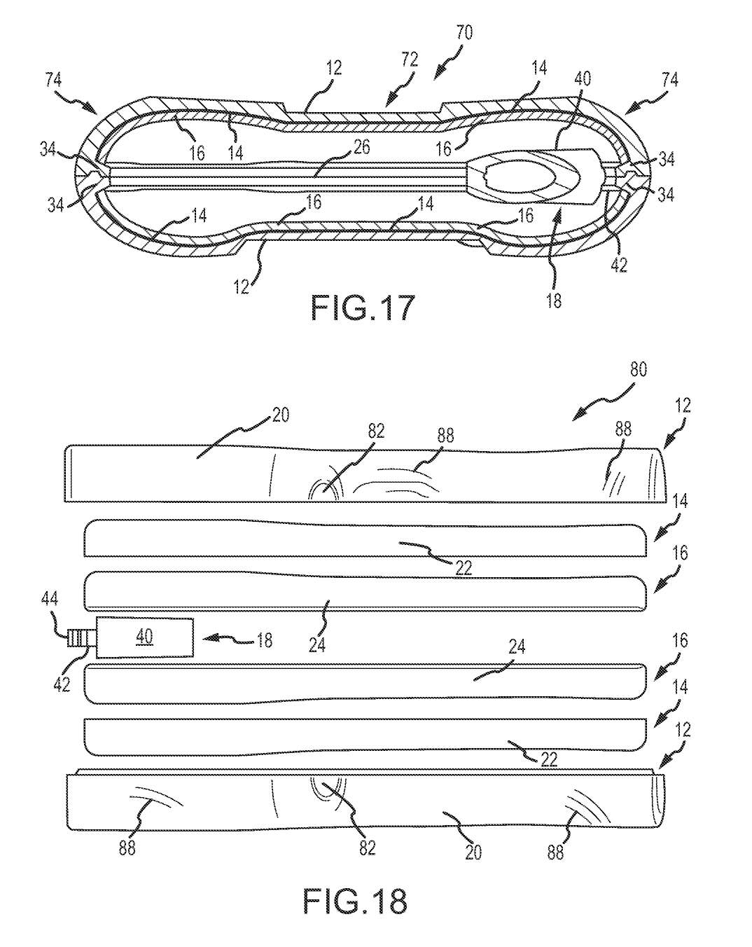

Referencing FIG. 17, the squeaker 18 in this embodiment, shown in a partial cross-sectional view, has a shorter neck 42 and a larger diameter body 40 as compared to the squeaker 18 in the third embodiment. This embodiment also includes the wedge 66 formed on the neck 42 of the squeaker to help stabilize the squeaker as it is held within the frame portion 68.

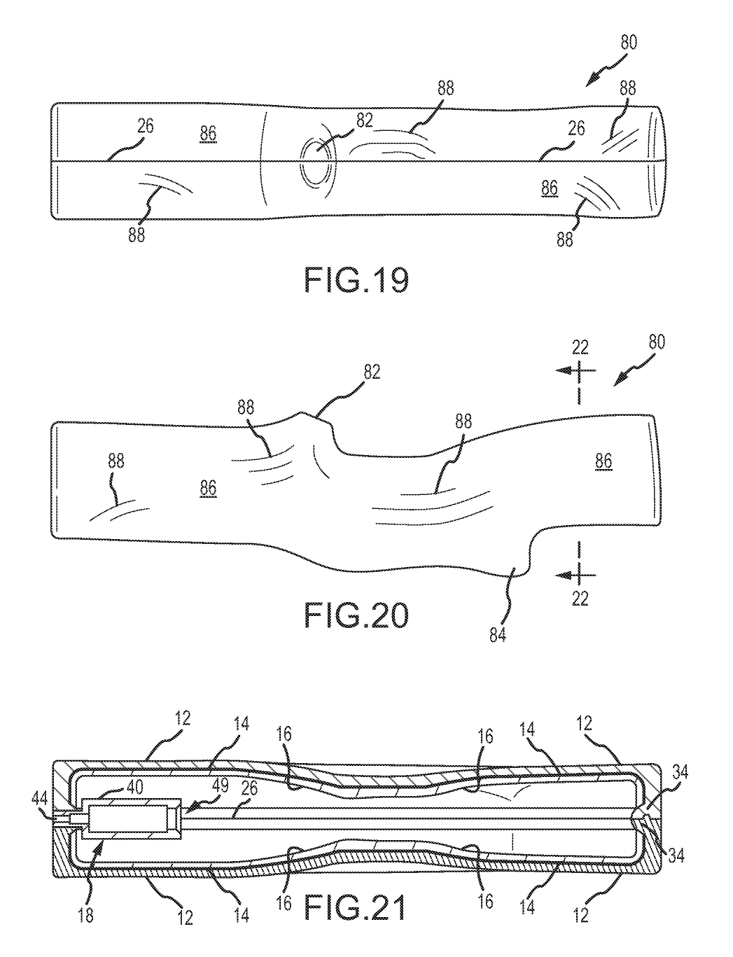

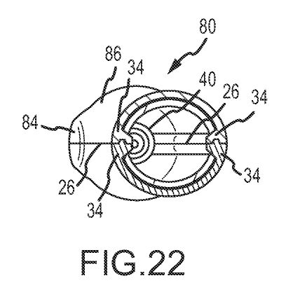

Referring to FIGS. 18-22, yet another preferred embodiment is illustrated in the shape of a twig or stick 80. This fourth embodiment can be described as further including a body 86 and surface features or irregularities that enhance the appearance of the toy to resemble a stick or twig. For example, FIGS. 19 and 20 show features on the outer shell 12 including a stub/base 82 resembling a stub of a removed branch, a knot 84, and roughened or uneven outer surface irregularities 88 resembling bark. This embodiment also incorporates the same general construction as the other embodiments in which the shells or layers of material are concentrically arranged and a squeaker 18 is disposed within the interior center chamber of the toy in the suspended orientation. The shape of the squeaker 18 in this embodiment resembles the general shape of the squeaker in the first embodiment.

The preferred embodiments of the invention illustrate the number of different shapes that can be used in the invention in which multi-layers or concentric shells are used. A squeaker may be held in a supported and protected position within the interior chamber of the pet toy. The half molded sections for the inner and outer shells simplify construction.

Although the invention is described in particular detail with respect to preferred embodiments and accompanying drawings, it shall be understood that the invention is not specifically limited to the preferred embodiments and is rather encompassed by the scope of the claims appended hereto.

What is claimed is:

1. A pet toy comprising:
an outer shell made of a first TPR material;
an inner shell made of a second TPR material;
an intermediate graphics layer positioned between and supported by said inner and outer shells; and
a noise making device having a first end supported by said inner and outer shells, and a second end extending within an interior chamber of said pet toy defined as space within interior surfaces of said inner shell, and wherein said second end is suspended and spaced from said interior surfaces.

2. A pet toy, as claimed in claim 1, wherein:
said outer and inner shells are molded in respective half sections and are joined to one another to assemble said pet toy.

3. A pet toy, as claimed in claim 1, wherein:
said half sections are each substantially symmetrical about an axis.

4. A pet toy, as claimed in claim 1, wherein:
said half sections of said inner and outer shells are sectioned along a substantially common joining line defined by contact between opposing joining surfaces of said half sections.

5. A pet toy, as claimed in claim 1, wherein:
one half section of an outer shell includes a peripheral flange and a groove or protrusion formed with said peripheral flange; and
the other half section of said outer shell includes a corresponding groove or protrusion for mating with said groove or protrusion of said one half section.

6. A pet toy, as claimed in claim 1, wherein the first TPR material of the outer shell is at least partially transparent.

7. A pet toy, as claimed in claim 1, wherein the first TPR material of the outer shell is more rigid than the second TPR material of the inner shell.

8. A pet toy, as claimed in claim 1, wherein the first TPR material of the outer shell is less rigid than the second TPR material of the inner shell.

9. A pet toy, as claimed in claim 1, wherein a first one of the outer and inner shells has a greater cross-sectional thickness than a second one of the outer and inner shells.

10. A pet toy, as claimed in claim 1, further comprising ribs incorporated on an interior surface of the inner shell.

11. A pet toy comprising:
an outer shell made of a first thermoplastic material;
an inner shell made of a second thermoplastic material;
an intermediate graphics layer positioned between and supported by said inner and outer shells;
a noise making device having a first end supported by said inner and outer shells, and a second end extending within an interior chamber of said pet toy defined as space within interior surfaces of said inner shell, said second end being suspended and spaced from said interior surfaces;
said outer and inner shells being molded in respective half sections and joined to one another to assemble said pet toy; and
said half sections are sectioned along a substantially common joining line defined by contact between opposing joining surfaces of said half sections.

12. A pet toy, as claimed in claim 11, wherein:
said outer shell is translucent or substantially transparent so that the intermediate graphics layer can be viewed.

13. A pet toy, as claimed in claim 11, wherein:
one half section of an outer shell includes a peripheral flange and a groove or protrusion formed with said peripheral flange; and
the other half section of said outer shell includes a corresponding groove or protrusion for mating with said groove or protrusion of said one half section.

14. A pet toy, as claimed in claim 11, wherein:
one shell of said outer or inner shells is made of a first elastomeric material having a first deformation strength, and the other shell of said inner and outer shells is made of a second elastomeric material having a second deformation strength.

15. A pet toy, as claimed in claim 11, wherein the outer shell has a first cross-sectional thickness and the inner shell has a different second cross-sectional thickness.

16. A pet toy, as claimed in claim 11, wherein the inner and outer shells are sized such that an exterior surface of the inner shell and an interior surface of the outer shell are in substantially uniformly contact with interior and exterior surfaces of the intermediate layer.

17. A method of stimulating an animal for play with a pet toy, the method comprising:
providing a pet toy including: an outer shell made of a first TPR material; an inner shell made of a second TPR material; an intermediate graphics layer positioned between and supported by said inner and outer shells; and a noise making device having a first end supported by said inner and outer shells, and a second end extending within an interior chamber of said pet toy defined as space within interior surfaces of said inner shell, and wherein said second end is suspended and spaced from said interior surfaces;
giving the pet toy to an animal for play; and
wherein the animal plays with the toy including biting the pet toy in which the inner and outer shells provide a differential resilient and elastomeric response to the biting action of the animal.

18. A method, as claimed in claim 17, wherein said outer shell is translucent so that the intermediate graphics layer can be viewed.

19. A method, as claimed in claim 17, wherein the outer shell has a greater first cross-sectional thickness than the inner shell.

20. A method, as claimed in claim 17, wherein the first TPR material of the outer shell is denser than the second TPR material of the inner shell.
